(19) United States
(12) Patent Application Publication
(10) Pub. No.: US 2020/0187704 A1
(43) Pub. Date: Jun. 18, 2020

(54) NEW DESIGN FOR TURKISH COFFEE POT

(71) Applicant: Turgay YILDIZLI, NEW ORLEANS, LA (US)

(72) Inventor: Turgay YILDIZLI, NEW ORLEANS, LA (US)

(21) Appl. No.: 16/346,898

(22) PCT Filed: Oct. 27, 2017
(86) PCT No.: PCT/TR2017/000114

§ 371 Date: May 2, 2019

(30) Foreign Application Priority Data
Nov. 2, 2016 (TR) 2016/15599

(51) Int. Cl. A47J 31/18

(52) U.S. Cl. CPC A47J 31/18

(57) ABSTRACT

A coffee pot including at least one concave dome formed in the coffee pot base. The concave dome formed at the base of the coffee pot is a concave dome or protrusion in the form of a hemisphere decreasing in diameter from the coffee pot base upwardly (into the cezve). A diameter of the concave dome is 20% to 75% of a diameter of the base of the coffee pot. A height of the concave dome is 60% to 10% of a diameter of the at least one concave dome. The concave dome is positioned at a center of the base, or the least one concave dome is positioned with an amount of axial misalignment; and the least one concave dome at the base of the coffee pot is smooth sided or created through a decreasing diameter of concentric circles one inside another.

### CROSS REFERENCE TO THE RELATED APPLICATIONS

This application is the national phase entry of International Application No. PCT/TR2017/000114, filed on Oct. 27, 2017, which is based upon and claims priority to Turkish Patent Application No. 2016/15599, filed on Nov. 2, 2016, the entire contents of which are incorporated herein by reference.

### TECHNICAL FIELD

This invention relates to the design of a new Turkish coffee pot which provides the best physical conditions for coffee making. This invention is of a coffee pot with a concave bottom which allows the fine particles of ground coffee to mix completely and brew in an ideal manner without settling to the bottom of the pot. In this coffee pot design, a semi-spherical hollow was formed inside the bottom portion of the coffee pot achieving the desired results.

### BACKGROUND

Coffee consumption in the world is spreading and increasing. As consumption increases so does coffee quality and variety, because of this many new tools and equipment are being developed. When considering prior art, it is observed that many of these technical developments are related to filtration and brewing of coffee.

Turkish coffee preparation is one of the oldest know methods of coffee preparation and uses a pot referred to as a Cezve or Ibrik (hereto after referred to as a Cezve). A Cezve is a pot in which finely ground coffee is heated with water to brew coffee (Turkish Coffee). The most important difference between Turkish Coffee and other coffee preparation techniques is that the coffee is not filtered during brewing or afterwards. The coffee grounds are very finely ground so that they will settle to the bottom of the cup after preparation and during service. The very fine grind of the coffee grounds can lead to over extraction of the coffee due to the increased number of particles and increased surface area. Due to the nature of the chemical constituents of the coffee bean, a maximum of 30-35% of the coffee bean can be dissolved into the solute, that is, the water. However if maximum extraction is reached, more caffeine and chlorogenic acid will be dissolved resulting in bitterness and the unwanted tastes in the coffee slurry. Brewing method variables can be controlled in order to achieve balanced and desired tastes in the coffee by reaching the ideal extraction yield of the coffee solution (18 to 22 percent for filtered coffee brewing methods).

The fineness of the coffee ground is one of the essential components of brewing Turkish coffee in a Cezve. Finely ground coffee and water are stirred together in the pot before brewing to prevent clumping and to insure an even extraction. If the coffee and water are not well mixed clumps will form causing the outside of said clumps to over extract and the inside to under extract. This will result in coffee that does not have an ideal taste profile. If the coffee slurry is excessively or too rapidly stirred, it increases agitation, and due to the fineness of the coffee particles results in over extraction creating increased bitterness and unwanted tastes in the coffee beverage. During the brewing, the convection and conduction heat transfer causes the warmed coffee-water mixture to rise and the cold mixture to descend, resulting in a natural turbulence in accordance with fluid dynamics. In addition, the increase in irregular turbulence caused by the release of thermal and chemical gases in the Cezve, while not strong enough to prevent clumping, is another factor that increases the extraction rate. Stirring especially while brewing causes increased agitation leading to over extraction.

### SUMMARY

The objective of the invention is to create a cezve with an advanced design having a semi-spherical hollow in the pot bottom in order to ensure ideal extraction of the coffee by creating a natural turbulence in the pot. This invention; a semi-spherical hollow in the pot bottom of a cezve, ibrik or brew pot with a similar purpose, decreases the instances of over extraction by naturally increasing turbulence, aiding in the prevention of clumping and eliminating the need for stirring the coffee slurry during brewing.

An important advantage of this invention is the elimination or reduction of the need to stir the coffee slurry by hand during brewing.

Another advantage of this invention is the natural turbulence created in the bottom of the pot leading to a more evenly mixed coffee slurry and the decrease in the occurrence of bitterness.

Another important advantage of this invention is that it enables the development of the ideal coffee flavors through the prevention of the formation of clumps ensuring all coffee particles are completely and evenly extracted.

The design of the cezve, the present invention, will be better understood from the figures and parts/section numbered below.

### BRIEF DESCRIPTION OF THE DRAWINGS

FIG. 1 shows an image of a prior art cezve for coffee brewing;

FIG. 2 shows a cross-sectional view as a conceptual design of the cezve of present invention;

FIG. 3 shows a perspective view of the cezve of present invention;

FIG. 4 shows a top view of the present invention; and

FIG. 5 shows a side view of the present invention.

### REFERENCE NUMBERS OF PARTS AND SECTIONS IN THE FIGURES ILLUSTRATING THE PRESENT INVENTION

1. Cezve
2. Cezve bottom
3. Semi-spherical hollow
R1—Cezve bottom diameter
R2—Semi-spherical hollow diameter
H1—Semi-spherical hollow height

### DETAILED DESCRIPTION OF THE EMBODIMENTS

The present invention of the coffee pot, Cezve, is designed primarily for the purpose of brewing Turkish coffee. However, the desired protection of the design can also be used not only for Turkish coffee, but also for coffee or tea brewing utensils suitable for similar purposes, or to be used for cooking vegetables, fruits, herbs and sauces.

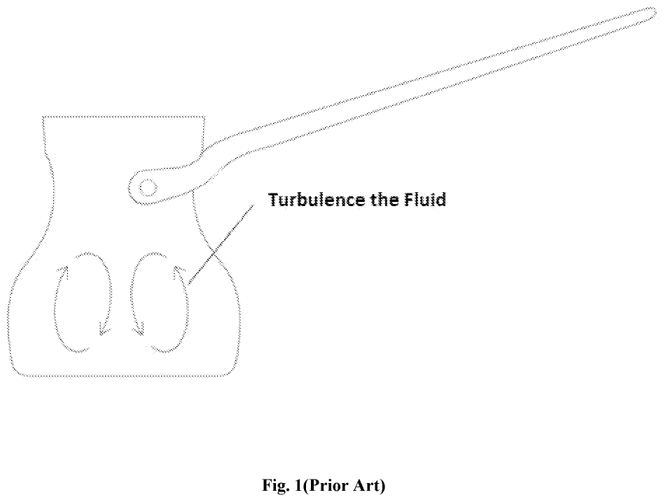

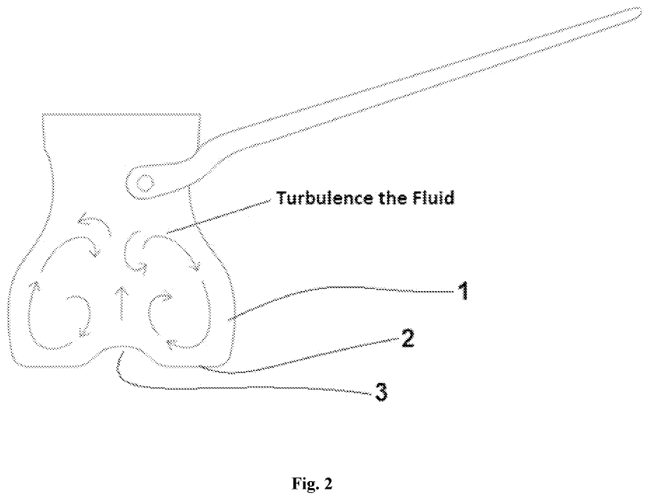

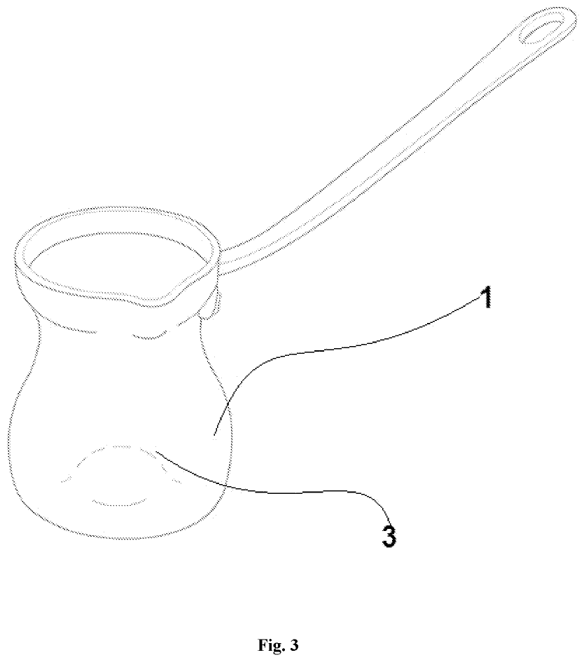

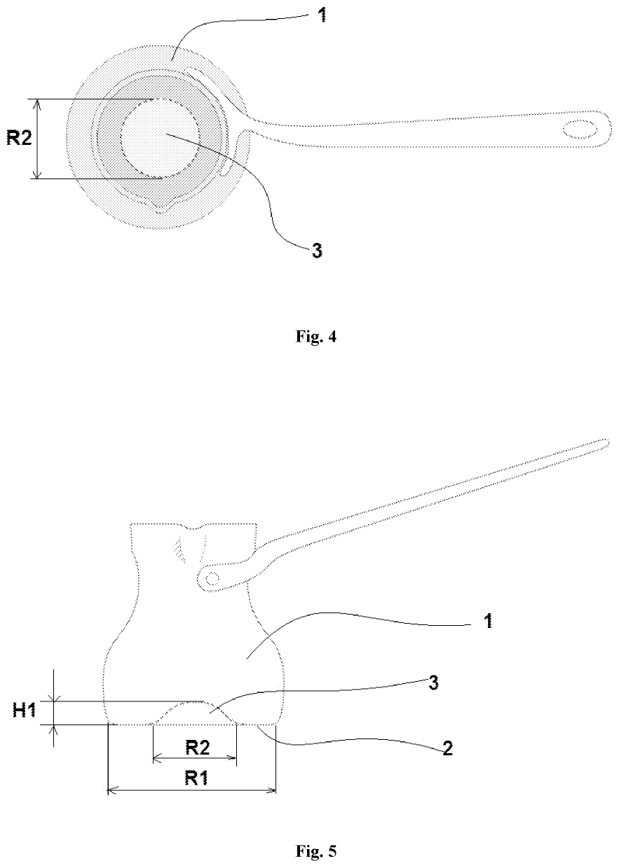

To better understand the invention of the new design coffee pot (Cezve) an example of prior art, a flat bottom Cezve, is shown in FIG. 1. FIG. 2 shows that the conceptual design of the invention differs from the prior art as well as the estimated fluid turbulence occurring in the pot. FIG. 3 shows said cezve's perspective image, FIG. 4 shows the invention from above and FIG. 5 shows the cezve from the side view. The cezve (1) that is the present invention contains at least one concave dome (3) formed at the base of the coffee pot (2). The cezve (1) can be produced from copper, iron, brass, glass, ceramics, alloys and composite materials. The cezve's base (2) is preferably flat. But if desired, it can be wavy, curved or sloped. The concave dome (3) formed at the base of the pot (2) starting from the base of the coffee pot (2) upwards (into the cezve) is a concave dome or protrusion in the shape of a semi-spherical hollow with decreasing diameter. The concave dome (3) is preferably semi-spherical in shape with a decreasing circular slope comparable to the shape of the end of an egg. The important thing is the cezve (1) has a curved surface that allows the fluid inside to generate turbulence when heat is applied. In this respect, the concave dome (3) may also be a hemisphere, a curved hollow, or even a conical structure. The diameter (R2) of the concave dome (3) of the cezve that is the subject of this invention may be 20% to 75% of the diameter of the base (R1) of the pot. That is, the concave dome (3) at the base of the coffee pot (2) can be large or small. In addition, the height of the dome (H1) in the concave dome (3) may be between 10% and 60% of the diameter of the dome (R2). That is, the concave dome (3) may be very high or only a low bump in the coffee pot.

The concave dome (3) in the base (2) of the cezve (1) that is the present invention is preferably formed at the center of the base of the cezve (2). However, if desired, it can be positioned with an axial misalignment. From the top view, the profile may be an ellipse rather than a full circle. Also the concave dome (3) at the base of the coffee pot (2) can be smooth sided or created through a decreasing diameter of concentric circles one inside the other.

The cezve (1) that is the present invention for brewing any kind of Turkish coffee or similarly for cooking vegetables, fruits, herbs and sauces can be produced in both large or small sizes. It is basically designed to facilitate the natural turbulence of the heated fluid; apart from coffee it can be used to prepare and serve hot chocolate, tea or heat milk and similar products.

What is claimed is:

1. A coffee pot, comprising: at least one concave dome formed in a base of the coffee pot.

2. The coffee pot according to claim 1, wherein, the at least one concave dome has a hemispheric shape, gradually decreasing in diameter from the base of the coffee pot upwards forming the at least one concave dome.

3. The coffee pot according to claim 1, wherein a diameter of the at least one concave dome is 20% to 75% of a diameter of the base of the coffee pot.

4. The coffee pot according to claim 1, wherein, a height of the at least one concave dome is 60% to 10% of a diameter of the at least one concave dome.

5. The coffee pot according to claim 1, wherein, least one concave is positioned at a center of the base, or the least one concave dome is positioned at the center of the base with an amount of axial misalignment of the center; and the least one concave dome at the base of the coffee pot is smooth sided or created through a decreasing diameter of concentric circles one inside another of the concentric circles.
